(19) United States
(12) Patent Application Publication
(10) Pub. No.: US 2011/0205410 A1
(43) Pub. Date: Aug. 25, 2011

(54) IMAGE SENSOR HAVING COLOR FILTERS

(75) Inventor: JUNGCHAK AHN, Yongin-si (KR)

(73) Assignee: Samsung Electronics Co., Ltd.

(21) Appl. No.: 12/975,028

(22) Filed: Dec. 21, 2010

(30) Foreign Application Priority Data
Feb. 19, 2010 (KR) 10-2010-0015305

(51) Int. Cl. H04N 5/335

(52) U.S. Cl. 348/273; 348/E05.091

(57) ABSTRACT

Provided is an image sensor having a color filter. The image sensor includes a photoelectric conversion device formed in a semiconductor substrate. Interlayer insulating layers are laminated on an upper portion of the semiconductor substrate. The interlayer insulating layers defines an opening located on an upper portion of the photoelectric conversion device. A color filter is disposed in the opening, and a planarization layer fills the opening on the color filter. The planarization layer has a refractive index which is greater than an average refractive index of the interlayer insulating layers.

### CROSS-REFERENCE TO RELATED APPLICATIONS

This U.S. non-provisional patent application claims priority under 35 U.S.C. §119 of Korean Patent Application No. 10-2010-0015305, filed on Feb. 19, 2010, the entire contents of which are hereby incorporated herein by reference.

### BACKGROUND

The present disclosure herein relates to an image sensor, and more particularly, to an image sensor having color filters.

An image sensor is a device that converts optical images into electrical signals. With development of the computer and communication industries, there may be an increasing demand for high performance image sensors which are widely used for capturing images in a variety of applications such as digital cameras, camcorders, personal communication systems (PCS's), gaming machines, security cameras, micro-cameras for medical applications, and/or robots.

Image sensors include CMOS image sensors. The CMOS image sensors operate with a simple driving way and may be integrated with signal processing circuits on a single chip, thus enabling products including the CMOS image sensors to be scaled down. In addition, the CMOS image sensors operate with low power consumption. Thus, the CMOS image sensors are applicable to portable electronic devices. Furthermore, the CMOS image sensors may be fabricated using CMOS fabrication techniques, thereby reducing manufacturing costs. With the technical development of the CMOS image sensors, high resolution can be realized. For this reason, the use of the CMOS image sensors is dramatically increasing.

### SUMMARY

Exemplary embodiments of the present disclosure are directed to image sensors having color filters.

In an embodiment of the inventive concept, the image sensor includes a photoelectric conversion device formed in a semiconductor substrate. Interlayer insulating layers are laminated on an upper portion of the semiconductor substrate. The interlayer insulating layers defines an opening located on an upper portion of the photoelectric conversion device. A color filter is disposed in the opening, and a planarization layer fills the opening on the color filter. The planarization layer has a refractive index which is greater than an average refractive index of the interlayer insulating layers.

In another embodiment of the inventive concept, the image sensor includes a semiconductor substrate having first to third pixel regions. A plurality of photoelectric conversion devices are disposed in the first to third pixel regions, respectively. A plurality of interlayer insulating layers are laminated on an upper portion of the semiconductor substrate, and the interlayer insulating layers defines openings which are located on the respective photoelectric conversion devices. A plurality of color filters are disposed on bottom surfaces of the openings, respectively. A planarization layer fills the openings located on the color filters. The planarization layer has a refractive index greater than an average refractive index of the interlayer insulating layers.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram illustrating a CMOS image sensor according to an embodiment of the inventive concept;

FIG. 2A is a circuit diagram illustrating an active pixel sensor (APS) array of FIG. 1;

FIG. 2B is a circuit diagram illustrating an active pixel sensor (APS) array of a CMOS image sensor according to another embodiment of the inventive concept;

FIG. 3 is a cross-sectional view illustrating the active pixel sensor (APS) array of the CMOS image sensor according to an embodiment of the inventive concept;

FIGS. 4 through 6 are cross-sectional views illustrating active pixel sensor (APS) arrays of the CMOS image sensors according to other embodiments of the inventive concept; and

FIG. 7 is a schematic block diagram illustrating a processor-based system including the image sensor according to the embodiments of the inventive concept.

### DETAILED DESCRIPTION OF THE EMBODIMENTS

Advantages and features of the present invention and methods of accomplishing the same may be understood more readily by reference to the following detailed description of preferred embodiments and the accompanying drawings. The exemplary embodiments of the inventive concept may, however, be embodied in many different forms and should not be construed as being limited to the embodiments set forth herein. Rather, these embodiments are provided so that this disclosure will be thorough and complete and will fully convey the scope of the inventive concept to those skilled in the art, and the embodiments of the inventive concept will only be defined by the appended claims. Like reference numerals refer to like elements throughout the specification.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes”, “including”, “comprises” and/or “comprising,” when used in this specification, specify the presence of stated elements, steps, operations, and/or components, but do not preclude the presence or addition of one or more other elements, steps, operations, and/or components.

Example embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

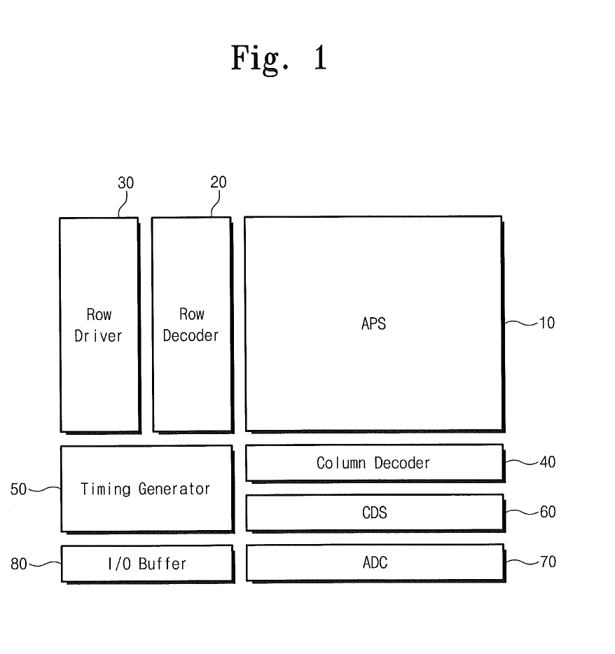

FIG. 1 is a block diagram illustrating a CMOS image sensor according to an embodiment of the inventive concept.

Referring to FIG. 1, the CMOS image sensor includes an active pixel sensor (APS) array 10, a row decoder 20, a row driver 30, a column decoder 40, a timing generator 50, a correlated double sampler 60, an analog to digital convertor 70, and an input/output (I/O) buffer 80.

The active pixel sensor array 10 includes a plurality of unit pixels arranged two-dimensionally. The active pixel sensor array 10 converts optical signals into electric signals. The active pixel sensor array 10 may be driven by a plurality of driving signals such as a pixel selection signal, a reset signal, and a charge transmission signal from the row driver 30. The converted electric signals are supplied to the correlated double sampler 60.

The row driver 30 supplies several driving signals for driving several unit pixels to the active pixel sensor array 10 in accordance with the decoded result obtained from the row decoder 20. When the unit pixels are arranged in a matrix shape, the driving signals may be supplied to the respective rows.

The timing generator 50 supplies a timing signal and a control signal to the row decoder 20 and the column decoder 40.

The correlated double sampler 60 receives the electric signals generated in the active pixel sensor array 10, and holds and samples the received electric signals. The correlated double sampler 60 performs double sampling on a specific noise level and a signal level of the electric signal to output a difference level corresponding to a difference between the noise level and the signal level.

The analog to digital convertor 70 converts analog signals corresponding to the difference level output from the correlated double sampler 60 into digital signals, and then the analog to digital convertor 70 outputs the converted digital signals.

The I/O buffer 80 latches the digital signals and sequentially outputs the latched signals to an image signal processing unit (not illustrated) in accordance with the decoding result obtained from the column decoder 40.

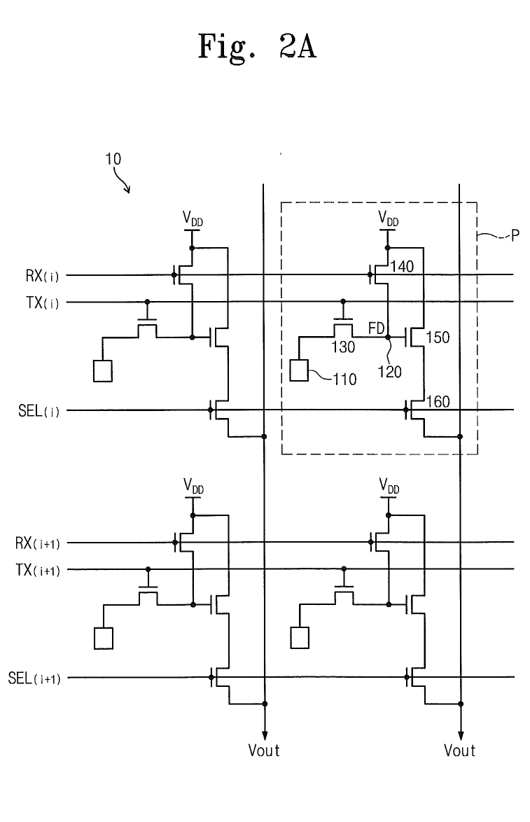

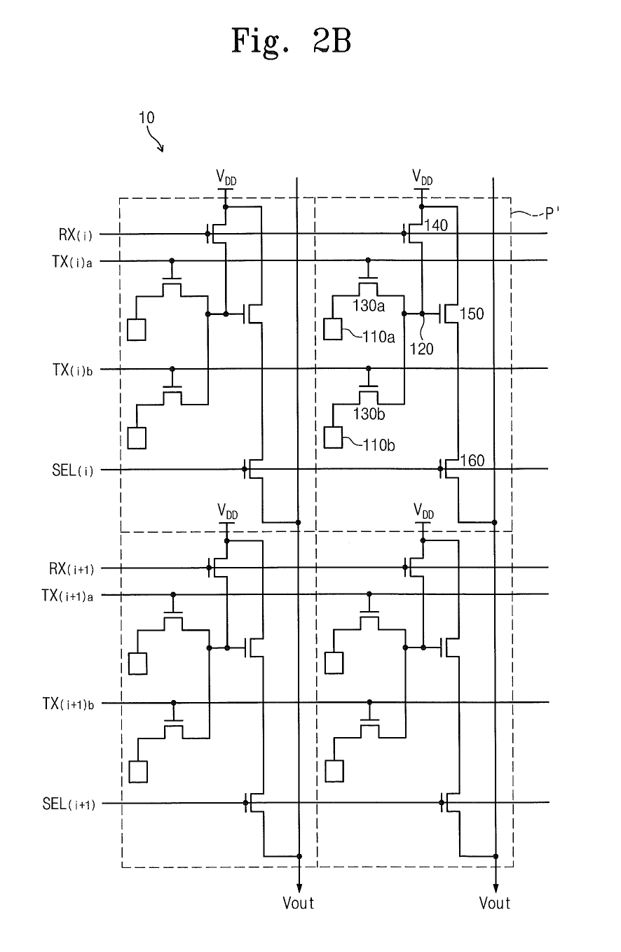

FIG. 2A is a circuit diagram illustrating an active pixel sensor (APS) array of the CMOS image sensor according to the embodiment of the inventive concept.

Referring to FIG. 2A, the plurality of unit pixels P are arranged in the matrix shape to constitute the active pixel sensor array 10 converting optical signals into electric signals in the image sensor.

According to FIG. 2A, the unit pixel P has a four-transistor structure, for example, a four NMOS transistor structure. However, the unit pixel P may have a three-transistor structure, a five-transistor structure, or a photo gate structure similar to the four-transistor structure.

Referring to FIG. 2A, the unit pixel P having the four NMOS transistor structure may be divided into a photoelectric conversion device 110 and a reading device. The photoelectric conversion device 110 receives light to generate and store electric charges, and the reading device reads an optical signal corresponding to the incident light irradiated onto the photoelectric conversion device 110. The reading device may include a reset device 140, an amplification device 150, and a select device 160.

More specifically, the photoelectric conversion device 110 generates and stores charges corresponding to the incident light. The photoelectric conversion device 110 may include at least one of a photo diode, a photo transistor, a photo gate, and a pinned photo diode (PPD). The photoelectric conversion device 110 is connected to a charge transmission device 130 transmitting the stored charges to a detection device 120.

A floating diffusion (FD) region may be used as the detection device 120, which receives the charges stored in the photoelectric conversion device 110. The detection device 120 accumulates charges. The detection device 120 is electrically connected to the amplification device 150 to control the amplification device 150.

The charge transmission device 130 transmits the charges in the photoelectric conversion device 110 to the detection device 120. The charge transmission device 130 generally has one transistor and is controlled by a bias applied to a charge transmission signal line TX(i).

The reset device 140 periodically resets the detection device 120. The source of the reset device 140 is connected to the detection device 120 and the drain of the reset device 140 is connected to a power supply terminal which has a power supply voltage V_{DD}. The reset device 140 is driven by a bias applied to a reset signal line RX(i). When the reset device 140 is turned on by the bias applied to the reset signal line RX(i), the power supply voltage V_{DD} is applied to the detection device 120. Therefore, the detection device 120 may be reset, when the reset device 140 is turned on.

The amplification device 150 serves as a source follower buffer amplifier together with a constant current source (not illustrated) located outside the unit pixel P. The amplification device 150 amplifies a variation in the electric potential of the detection device 120 and outputs the amplified variation in the electric potential to an output line Vout through the select device 160.

The select device 160 selects one of the unit pixels in a single row. The select device 160 is driven by a bias applied to a row select signal line SEL(i). When the select device 160 is turned on, the output signal of the amplification device 150 is transmitted to the output line Vout.

The driving signal lines TX(i), RX(i), and SEL(i) are electrically connected to the charge transmission devices 130, the reset devices 140, and the select devices 160, respectively. The driving signal lines TX(i), RX(i), and SEL(i) extend in a row direction (horizontal direction) so as to simultaneously drive the unit pixels arrayed in the same row.

FIG. 2B is a circuit diagram illustrating an active pixel sensor (APS) array of a CMOS image sensor according to another embodiment of the inventive concept.

Referring to FIG. 2B, the active pixel sensor array 10 includes a plurality of 2-shared pixels P′ arranged in a matrix shape. In each of the 2-shared pixels P′, two photoelectric conversion devices 110a and 110b may share reading devices 140, 150, and 160. That is, two photoelectric conversion devices 110a and 110b may share a single reset device 140, a single amplification device 150, and a single select device 160.

Specifically, the 2-shared pixel P′ includes two photo diodes 110a and 110b. When incident lights are irradiated onto the photo diodes 110a and 110b, the photo diodes 110a and 110b may generate and store electric charges corresponding to the amounts of the incident lights. The photo diodes 110a and 110b may be substituted by any devices capable of generating and storing the charges corresponding to the incident lights. For example, a photo transistor, a photo gate, a pined photo diode, or a combination thereof may be used as the photo diodes 110a and 110b.

The photo diodes 110a and 110b are connected to the charge transmission devices 130a and 130b transmitting the stored charges, respectively. The charges transmitted through the charge transmission devices 130a and 130b are accumulated in the detection device 120. If the charges in the photo diodes 110a and/or 110b are transmitted into the detection device 120, the potential of the detection device 120 may be changed.

The reset device 140 periodically resets the detection device 120. The reset device 140 may include one MOS transistor driven by a bias applied to the reset signal line RX(i).

When the reset device 140 is turned on by the bias applied to the reset signal line RX(i), a predetermined electric potential applied to the drain of the reset device 140, for example, the power supply voltage V_{DD} is transmitted to the detection device 120.

The amplification device 150 amplifies a variation in the electric potential of the detection device 120 receiving the charges accumulated in the photo diodes 110a and 110b and outputs the amplified variation in the electric potential to the output line Vout through the select device 160.

The select device 160 selects one of the 2-shared pixels P′ in a single row. The select device 160 may include one MOS transistor driven by a bias applied to the row select signal line SEL(i).

Therefore, when the select device 160 is turned on by a bias applied to the row select signal line SEL(i), the output signal of the amplification device 150 is transmitted to the output line Vout.

A pair of transmission signal lines TX(i)a and TX(i)b are connected to the charge transmission devices 130a and 130b, respectively. The transmission signal lines TX(i)a and TX(i)b may extend in a direction which is parallel with the row. All the charge transmission devices 130a in a single row are electrically connected by the transmission signal line TX(i)a. Similarly, all the charge transmission devices 130b in a single row are electrically connected by the transmission signal line TX(i)b. Thus, the charge transmission devices 130a in a single row may be controlled by a bias applied to the transmission signal line TX(i)a, and the charge transmission devices 130b in a single row may be controlled by a bias applied to the transmission signal line TX(i)b. The reset signal line RX(i) and the row select signal line SEL(i) may extend substantially in parallel to apply a reset bias and a select bias to the reset device 140 and the select device 160, respectively.

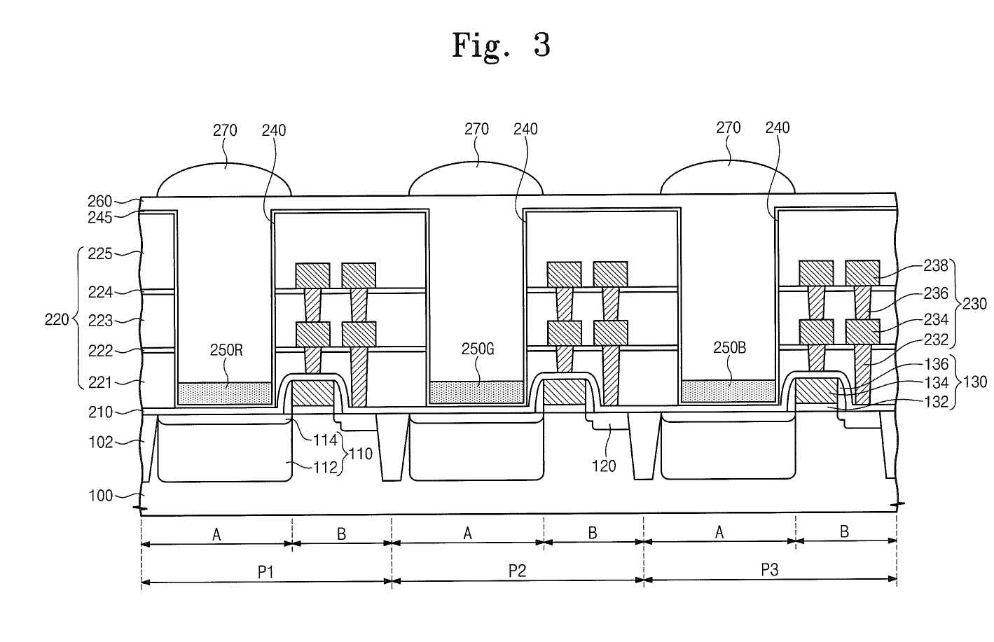

FIG. 3 is a cross-sectional view illustrating the active pixel sensor array of the CMOS image sensor according to an embodiment of the inventive concept.

Referring to FIG. 3, the active pixel sensor array 10 includes a first pixel region P1, a second pixel region P2, and a third pixel region P3. Each of the first pixel region P1, the second pixel region P2, and the third pixel region P3 may include a light-receiving region A and an interconnection region B formed adjacent to the light-receiving region A. The light-receiving region A may include the photoelectric conversion device 110, a light transmission section (or an optical waveguide), a color filter 250R, 250G, or 250B, and a microlens 270. The interconnection region B may include logic devices 120 and 130 (140, 150, and 160 in FIGS. 2A and 2B), which read electric signals transmitted from the photoelectric conversion device 110, and an interconnection structure 230 electrically connected to the logic devices 120 and 130 (140, 150, and 160 in FIGS. 2A and 2B). The logic devices may include the charge transmission device 130 (FIGS. 2A and 2B), the detection device 120 (FIGS. 2A and 2B), the amplification device 140 (FIGS. 2A and 2B), the select devices 150 (FIGS. 2A and 2B), and the reset device 160 (FIGS. 2A and 2B).

More specifically, the photoelectric conversion device 110 and the logic devices 120 and 130 (140, 150, and 160 in FIGS. 2A and 2B) are formed in a semiconductor substrate 100. An n-type or p-type semiconductor substrate 100 may be used as the semiconductor substrate 100. Alternatively, an epitaxial substrate having an n-type or p-type epitaxial layer formed on a bulk substrate may be used as the semiconductor substrate 100.

A device-isolating layer 102 may be formed in the semiconductor substrate 100. The device-isolating layer 102 may act as a field region and define a plurality of active regions. The active regions may be isolated from each other by the device-isolating layer 102 plurality of. The photoelectric conversion device 110 and the logic devices 120 and 130 (140, 150, and 160 in FIGS. 2A and 2B) may be formed in the active regions of the semiconductor substrate 100.

A deep well (not illustrated) may be formed in the semiconductor substrate 100. The deep well may serve as a potential barrier which prevents electric charges generated in a deep portion of the semiconductor substrate 100 from flowing into the photoelectric conversion device 110. The deep well may also serve as a cross-talk barrier that reduces cross-talk between pixels by random drift of the charges by increasing recombination of electrons and holes.

The photoelectric conversion device 110 is formed in each of the light-receiving regions A of the pixel regions P1, P2, and P3. The photoelectric conversion device 110 receives the incident light and stores charges corresponding to the amount of the incident light. A photo diode, a photo transistor, a photo gate, a pinned photo diode, or a combination thereof may be used as the photoelectric conversion device 110. In embodiments of the inventive concept, a pinned photo diode is formed in the semiconductor substrate 100. The photoelectric conversion device 110 is coupled with the charge transmission device 130 transmitting the charges stored in the photoelectric conversion device 110 to the floating diffusion region 120.

More specifically, the photoelectric conversion device 110 may be formed to have impurity regions in the semiconductor substrate 100. The photoelectric conversion device 110 may include an n-type impurities region 112 and a p-type impurity region 114. The n-type impurity region 112 is formed deeply in the semiconductor substrate 100. The p-type impurity region 114 is formed shallowly at the surface of the n-type impurity region 112. The photoelectric conversion device 110 may be formed at a depth of about 1 μm to about 10 μm from the surface of the semiconductor substrate 100.

The n-type impurity region 112 of the photoelectric conversion device 110 absorbs the incident light to generate and store charges. The p-type impurity region 114 prevents electron-hole pairs (EHP) from being thermally generated at the surface of the semiconductor substrate 100, thereby reducing dark current. The dark current may be generated by surface damage of the semiconductor substrate 100 which is due to dangling bonds and/or etching stresses.

The floating diffusion region 120 serving as the detection device is formed in each of the pixel regions P1, P2, and P3. The floating diffusion region 120 may be an impurity doped region spaced apart from the photoelectric conversion device 110. The floating diffusion region 120 may include a low-concentration impurity region and a high-concentration impurity region. That is, the floating diffusion region 120 has a lightly doped drain (LDD) structure or a double diffused drain (DDD) structure.

The floating diffusion region 120 receives the electric charges stored in the photo conversion device 110 through the charge transmission device 130. Since the floating diffusion region 120 has parasitic capacitance such as junction capacitance, the charges may be accumulated in the floating diffusion region 120. The potential of the floating diffusion region 120 may be varied by the charges introduced into the floating diffusion region 120. Thus, the amount of charges generated in the photoelectric conversion device 110 may be detected through the variation in the potential of the floating diffusion region 120.

The charge transmission device 130 may be disposed on the semiconductor substrate 100 between the floating diffusion region 120 and the photoelectric conversion device 110. The charge transmission device 130 transmits the charges stored in the photoelectric conversion device 110 to the floating diffusion region 120. The charge transmission device 130 includes a gate insulating layer 132 on the semiconductor substrate 100, a gate electrode 134 on the gate insulating layer 132, and spacers 136 on both sides of the gate electrode 134.

In each of the pixel regions P1, P2, and P3, an insulating structure 220 including a plurality of interlayer insulating layers 221, 223, and 225 may be formed on the semiconductor substrate 100 including the photoelectric conversion device 110 and the logic devices 120 and 130 (140, 150, and 160 in FIGS. 2A and 2B).

Specifically, the plurality of insulating layers 221, 223 and 225 may be formed on the entire surface of the semiconductor substrate 100. Etching stop layers 222 and 224 may be intervened between the interlayer insulating layers 221, 223, and 225. The interlayer insulating layers 221, 223, and 225 may be formed of a material having an excellent gap fill characteristic. The upper portions of the interlayer insulating layers 221, 223, and 225 may be planarized. Each of the interlayer insulating layers 221, 223 and 225 may be formed of at least one of a high density plasma (HDP) oxide layer, a tetraethylothorsilicate (TEOS) layer, a tonensilazen (TOSZ) layer, a spin on glass (SOG) layer, an undoped silicate glass (USG) layer, and a high-k dielectric layer. The etching stop layers 222 and 224 may be formed of at least one of a silicon nitride layer and a silicon oxynitride layer.

In some embodiments, a surface passivation layer 210 may be formed on the substrate including the photoelectric conversion device 110 and the logic devices 120 and 130 (140, 150, and 160 in FIGS. 2A and 2B) prior to formation of the insulating structure 220. The surface passivation layer 210 is formed to protect the surfaces of the photoelectric conversion device 110 and the logic devices 120 and 130 (140, 150, and 160 in FIGS. 2A and 2B). The surface passivation layer 210 may be used as an etching stop layer, when an opening 240 is formed in the insulating structure 220. The surface passivation layer 210 may be formed of a silicon nitride layer or a silicon oxynitride layer.

In the insulating structure 220 on the interconnection region B, an interconnection structure 230 is disposed to provide electrical interconnections between the logic devices 120 and 130 (140, 150, and 160 in FIGS. 2A and 2B) and to prevent external lights from being irradiated onto the interconnection region B. That is, the interconnection structure 230 may be located above the charge transmission device 130, the floating diffusion region 120, and the logic devices 120 and 130 (140, 150, and 160 in FIGS. 2A and 2B). The interconnection structure 230 includes a plurality of contact plugs 232 and 236 and interconnections 234 and 238. This interconnection structure 230 may be formed by depositing and patterning conductive layers or by performing a damascene process. The contact plugs 232 and 236 and the interconnections 234 and 238 may be formed of a metal material such as copper (Cu), aluminum (Al), or tungsten (W). The height of the interconnection structure 230 may be increased with improvement in the function of the image sensor. It is apparent to those skilled in the art that the arrangement of the interconnections 234 and 238 may be modified in various forms.

The refractive index of the insulating structure 220 may be relatively low. Therefore, the intensity and/or amount of the incident lights passing through microlenses 270 may be abruptly reduced when penetrating the insulating structure 220. Accordingly, a light transmission section (or an optical waveguide) may be formed in each of the light-receiving regions A to prevent the amount of the incident light from decreasing when the incident light penetrates the insulating structure 220.

Specifically, each of the light transmission sections has an opening 240 (or a cavity) formed by removing a part of the insulating structure 220 located above the light-receiving region A. A bottom surface of the opening 240 may be located at a lower level than the lowermost interconnection 234 in the interconnection structure 230. According to an embodiment of the inventive concept, the opening 240 may expose the surface passivation layer 210 on the photoelectric conversion device 110.

An antireflective layer 245 may be formed on sidewalls (e.g., inner walls) of the openings 240. The antireflective layer 245 may be formed to prevent the incident light from being reflected at surfaces of the insulating structure 220 and to guide the incident light onto the photoelectric conversion device 110 without loss thereof. The antireflective layer 245 on the sidewalls of the openings 240 may extend onto an upper surface of the insulating structure 220. The antireflective layer 245 may be formed of a SiON layer, a SiC layer, a SiCN layer, a SiCO layer, or the like.

The color filters 250R, 250G, and 250B are disposed in the first pixel region P1, the second pixel region P2, and the third pixel region P3, respectively. In order to obtain a high-quality image, each of the color filters 250R, 250G, and 250B passes only a light of a specific wavelength therethrough so that only the specific light reaches one of the photoelectric conversion devices 110. For example, the color filter 250R may pass only a red light therethough so that only the red light is irradiated onto the photoelectric conversion device 110 in the first pixel region P1. Further, the color filter 250G may pass only a green light therethough so that only the green light is irradiated onto the photoelectric conversion device 110 in the second pixel region P2. In addition, the color filter 250B may pass only a blue light therethough so that only the blue light is irradiated onto the photoelectric conversion device 110 in the third pixel region P3. Accordingly, the color filters 250R, 250G, and 250B may correspond to a red color filter, a green color filter and a blue color filter, respectively. In other embodiments, the color filters 250R, 250G, and 250B may pass only a magenta light, a cyan light, and a yellow light, respectively. That is, the color filters 250R, 250G, and 250B may correspond to a magenta color filter, a cyan color filter and a yellow color filter, respectively.

The color filters 250R, 250G, and 250B may be formed using a dyeing process, a pigment dispersion process, a printing process, or the like. In an embodiment, the color filters 250R, 250G, and 250B may be formed of a dyed photoresist layer having a thickness of about 1 μm.

The color filters 250R, 250G, and 250B may be formed in the openings 240, as illustrated in FIG. 3. In this case, there is no need to form additional color filters at positions over the openings 240. Thus, it is possible to reduce a vertical height of the image sensor chip when the color filters 250R, 250G and 250B are formed inside the openings 240. Further, in the event that the color filters 250R, 250G and 250B are formed inside the openings 240, it is possible to reduce a distance between the microlens 270 formed over the opening 240 and the photoelectric conversion device 110 below the opening 240. Therefore, since the amount of light reaching the photoelectric conversion device 110 is increased, it is possible to improve the optical sensitivity of the image sensor.

According to an embodiment of the inventive concept, at least one of the color filters 250R, 250G, and 250B may be disposed at a lower level than the lowermost interconnection 234 of the interconnection structure 230. That is, the color filters 250R, 250G, and 250B may be located at a level between the semiconductor substrate 100 and the lowermost interconnection 234. Moreover, The color filters 250R, 250G, and 250B may be located on the bottom surfaces of the openings 240. Furthermore, the color filters 250R, 250G, and 250B may be in contact with a top surface of the surface passivation layer 210. In this case, the antireflective layer 245 on the bottom surface of the opening 240 may be removed. The color filters 250R, 250G, and 250B may have a refractive index greater than an average refractive index of the insulating structure 220. This is for increasing the amount of the incident lights irradiated onto the photoelectric conversion devices 110. Here, the average refractive index of the insulating structure 220 corresponds to a mean value of the refractive indexes of the interlayer insulating layers 221, 223, and 225 and the etching stop layers 222 and 224.

The openings 240 on the color filters 250R, 250G, and 250B are filled with a planarization layer 260 having a refractive index greater than the average refractive index of the insulating structure 220. The planarization layer 260 may fill the openings 240 and also cover the upper surface of the insulating structure 220 to eliminate a step difference occurring on the surface of the insulating structure 220. The planarization layer 260 may be planarized or etched back to expose the upper surface of the insulating structure 220. In this case, the planarization layer 260 may be finally formed only in the openings 240. That is, the planarization layer 260 on the upper surface of the insulating structure 220 may be removed during the planarization process.

Specifically, when the interlayer insulating layers 222, 224 and 226 are formed of a silicon oxide layer, the planarization layer 260 may be formed of a material having a refractive index greater than that of the silicon oxide layer. For example, the planarization layer 260 may be formed of a material having a refractive index of about 1.4 to about 4.0. In an embodiment, the planarization layer 260 may be formed of an aluminum oxide (Al₂O₃) layer, a cerium fluoride (CeF₃) layer, a hafnium oxide (HfO₂) layer, an indium tin oxide (ITO) layer, a magnesium oxide (MgO) layer, a tantalum oxide (Ta₂O₅) layer, a titanium oxide (TiO₂) layer, a zirconium oxide (ZrO₂) layer, a silicon (Si) layer, a germanium (Ge) layer, a ZnSe layer, a zinc sulfide (ZnS) layer, a PbF₂ layer, or the like.

Alternatively, the planarization layer 260 may be formed of an organic material with a high refractive index. For example, the planarization layer 260 may be formed of a siloxane resin layer, a benzocyclobutene (BCB) layer, a polyimide-based material layer, an acryl-based material layer, a parylene C layer, a poly(methyl methacrylate) (PMMA) layer, a polyethylene terephthalate (PET) layer, or the like.

Alternatively, the planarization layer 260 may be formed of a strontium titanate (SrTiO₃) layer, a polycarbonate layer, a glass layer, a bromine layer, a sapphire layer, a cubic zirconia layer, a potassium Niobate (KNbO₃) layer, a moissanite (SiC) layer, a gallium (III) phosphide (GaP) layer, a gallium (III) arsenide (GaAs) layer, or the like.

The refractive index of the planarization layer 260 may be equal to or greater than that of the color filters 250R, 250G, and 250B formed in the lower portion of the openings 240.

According to another embodiment of the inventive concept, the planarization layer 260 may include a plurality of refractive layers having different refractive indexes from each other. For example, the planarization layer 260 may include a plurality of refractive layers which are sequentially stacked. In this case, each of the openings 240 may be filled with the plurality of refractive layers having different refractive indexes. Alternatively, the openings 240 on the color filters 250R, 250G and 250B may be filled with different planarization layers, respectively. For example, the openings 240 on the color filters 250R, 250G and 250B may be filled with first to third planarization layers which are different from each other in terms of refractive index.

The microlenses 270 are located on the planarization layer 260. The microlenses 270 are disposed to correspond to the pixel regions, respectively. The microlenses 270 concentrate the external lights (e.g., the incident lights) onto the photoelectric conversion devices 110 by changing the paths of the incident lights to be irradiated onto the regions outside the photoelectric conversion devices 110.

Each of the microlenses 270 may be formed of a light-transmitting material and may have a predetermined radius of curvature to concentrate the light. For example, the microlenses 270 may be formed of thermosetting resin having a light-transmitting property. The microlenses 270 may be formed by forming light transmitting patterns and then reflowing the light transmitting patterns to make convex upper surfaces. The curvature radius of the microlens 270 depends on the wavelength of the incident light irradiated onto each of the pixel regions P1, P2, and P3. For example, in a pixel region on which a long-wavelength light is irradiated, the microlens 270 may be formed to have a relatively short radius of curvature of the microlens 270. This is for reducing a focal length of the microlens 270. In contrast, in a pixel region on which a short-wavelength light is irradiated, the microlens 270 may be formed to have a relatively long radius of curvature of the microlens 270. This is for increasing a focal length of the microlens 270.

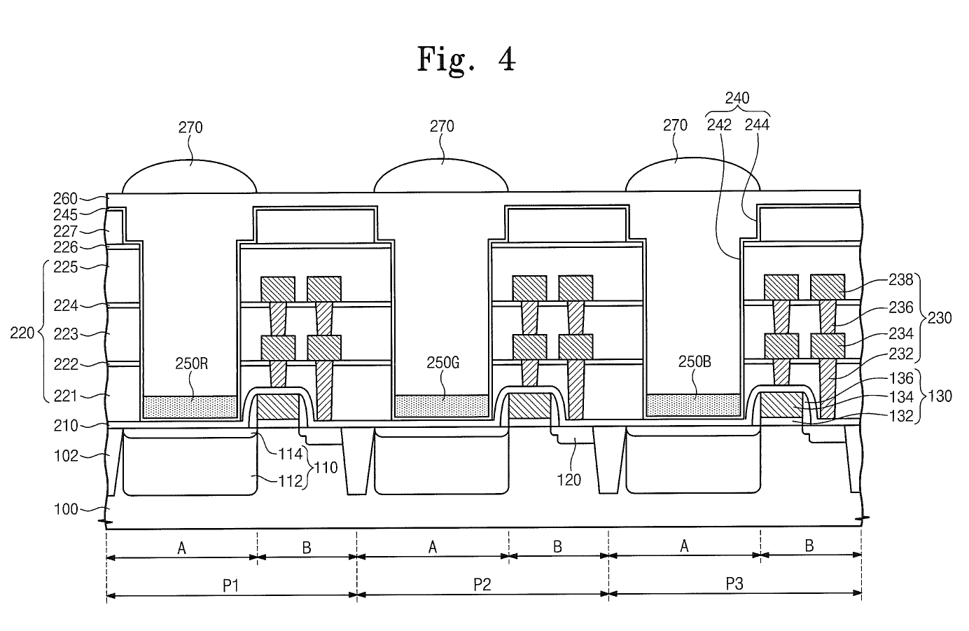

Hereinafter, CMOS image sensors according to other embodiments of the inventive concept will be described with reference to FIGS. 4 through 6. The descriptions to the same elements as described in the embodiment illustrated in FIG. 3 may be omitted in the following embodiments.

FIG. 4 is a cross-sectional view illustrating an active pixel sensor array of the CMOS image sensor according to another embodiment of the inventive concept.

In the active pixel sensor array, the height of the insulating structure 220 may be increased with an increase in the height of the interconnection structure 230. Therefore, if the vertical height of the interconnection structure 230 increases, the vertical depth of the openings 240 penetrating the insulating structure 220 may also be increased. The openings 240 may be formed by etching the insulating structure 220. Thus, in the event that only the vertical depth of the openings 240 increases without increase of a width of the openings 240, a lower width of the openings 240 may be dramatically reduced as compared to an upper width of the openings 240. This is due to the nature of etching process. For this reason, the amount of light incident on each of the photoelectric conversion devices 110 may be decreased. Therefore, in order to increase the amount of light incident on each of the photoelectric conversion devices 110, the openings 240 may be formed to have a stepped sidewall profile, as illustrate in FIG. 4.

More specifically, the insulating structure 220 may include the plurality of interlayer insulating layers 221, 223, and 225 as well as the etching stop layers 222 and 224 intervened between the interlayer insulating layers 221, 223, and 225. Further, an etching stop layer 226 and an interlayer insulating layer 227 may be laminated on the insulating structure 220.

In the present embodiment, each of the openings 240 may include a lower opening 242 and an upper opening 244. A width of the upper opening 244 is greater than that of the lower opening 242. Thus, a step difference may be formed between the lower opening 242 and the upper opening 244, as illustrate in FIG. 4. The lower opening 242 may be formed in the interlayer insulating layers 221, 223, and 225 of the insulating structure 230. The upper opening 244 may be formed in the uppermost etching stop layer 226 and the interlayer insulating layer 227 of the interconnection structure 230.

As described in the above embodiment, the color filters 250R, 250G, and 250B may be formed inside the openings 240. The remaining openings 240 on the color filters 250R, 250G, and 250B may be filled with the planarization layer 260 having a refractive index greater than the average refractive index of the insulating structure 220. The planarization layer 260 may be formed of a material having a refractive index which is greater than that of the silicon oxide layer. For example, the planarization layer 260 may be formed of a material having a refractive index of about 1.4 to about 4.0. In more detail, the planarization layer 260 may be formed of an aluminum oxide (Al₂O₃) layer, a cerium fluoride (CeF₃) layer, a hafnium oxide (HfO₂) layer, an indium tin oxide (ITO) layer, a magnesium oxide (MgO) layer, a tantalum oxide (Ta₂O₅) layer, a titanium oxide (TiO₂) layer, a zirconium oxide (ZrO₂) layer, a silicon (Si) layer, a germanium (Ge) layer, a ZnSe layer, a zinc sulfide (ZnS) layer, a PbF₂ layer, or the like.

Alternatively, the planarization layer 260 may be formed of an organic material with a high refractive index. For example, the planarization layer 260 may be formed of a siloxane resin layer, a benzocyclobutene (BCB) layer, a polyimide-based material layer, an acryl-based material layer, a parylene C layer, a poly(methyl methacrylate) (PMMA) layer, a polyethylene terephthalate (PET) layer, or the like.

In the embodiment illustrated in FIG. 4, a method of forming the openings 240 may include forming the interlayer insulating layers 221, 223 and 225 as well as the etching stop layers 222 and 224 intervened between the interlayer insulating layers 221, 223 and 225. The additional etching stop layer 226 is formed on the interlayer insulating layer 225. The interlayer insulating layers 221, 223 and 225 as well as the etching stop layers 222, 224 and 226 are patterned to form the lower openings 242. A sacrificial layer is formed in the lower openings 242. The additional interlayer insulating layer 227 is formed on the etching stop layer 226 and on the sacrificial layer. The interlayer insulating layer 227 is patterned to form the upper openings 244 having a width greater than that of the lower openings 242. The sacrificial layer in the lower openings 242 is then removed.

Alternatively, the openings 240 illustrated in FIG. 4 may be formed using another method. This method may include forming the interlayer insulating layers 221, 223, 225 and 227 as well as the etching stop layers 222, 224 and 226 intervened between the interlayer insulating layers 221, 223, 225 and 227. The topmost interlayer insulating layer 227 is patterned to form the upper openings 244. The interlayer insulating layers 221, 223 and 225 as well as the etching stop layers 222, 224 and 226 are patterned to form the lower openings 242 having a width less than that of the upper openings 244.

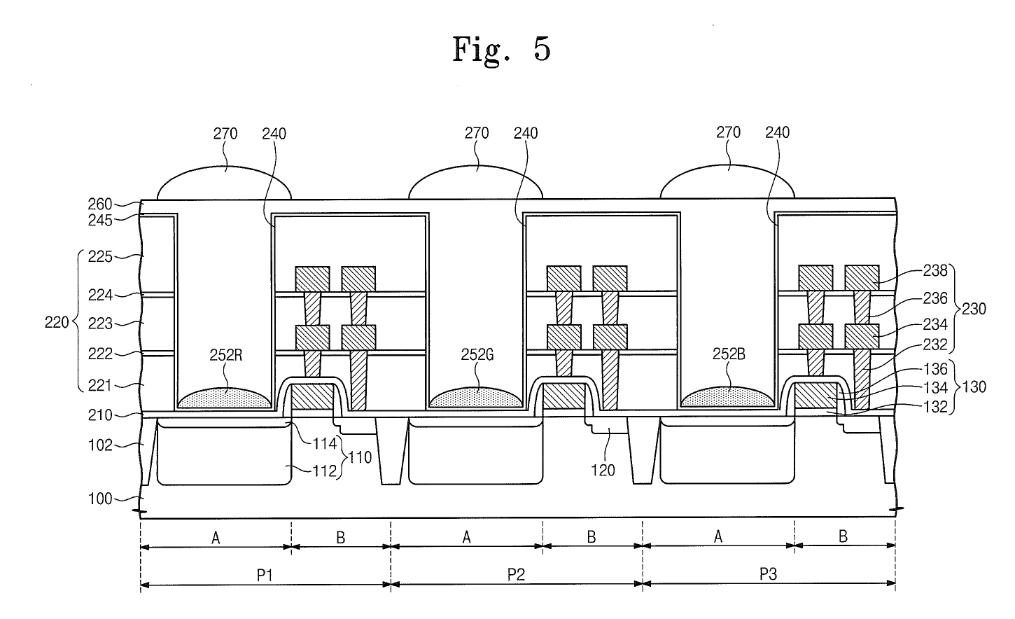

FIG. 5 is a cross-sectional view illustrating the CMOS image sensor according to still another embodiment of the inventive concept.

Referring to FIG. 5, color filters 252R, 252G, and 252B formed in the openings 240 may have a predetermined radius of curvature, like the microlenses 270. For example, the color filters 252R, 252G and 252B may be formed to have a convex upper surface. Thus, each of the color filters 252R, 252G and 252B may pass only a light having a specific wavelength and may concentrate the specific light. The color filters 252R, 252G, and 252B having the convex upper surfaces may be formed using a reflow process. That is, a plurality of color filter patterns are formed in the openings 240, respectively. The color filter patterns are then reflowed at an appropriate temperature. As a result, the color filters 252R, 252G and 252B may be formed to have the convex upper surfaces. After formation of the color filters 252R, 252G and 252B, the planarization layer 260 is formed to fill the remaining openings 240 on the color filters 252R, 252G and 252B.

When the color filters 252R, 252G, and 252B having the convex upper surfaces are formed in the openings 240, the curvature radii of the convex upper surfaces of the color filters 252R, 252G, and 252B may depend on the wavelengths of the incident lights irradiated onto the photoelectric conversion devices 110 in the pixel regions P1, P2, and P3, respectively. For example, when the wavelength of the incident light irradiated onto the photoelectric conversion device 110 in the pixel region P1 is greater than the wavelength of the incident light irradiated onto the photoelectric conversion device 110 in the pixel region P2, the color filter 252R in the pixel region P1 may be formed to have a focal length which is less than that of the color filter 252G in the pixel region P2. That is, the curvature radius of the convex upper surface of the 252R may be less than the curvature radius of the convex upper surface of the 252G.

As described in the above embodiment of the inventive concept, the openings 240 on the color filters 252R, 252G, and 252B may be filled with the planarization layer 260 having the refractive index greater than the average refractive index of the insulating structure 220.

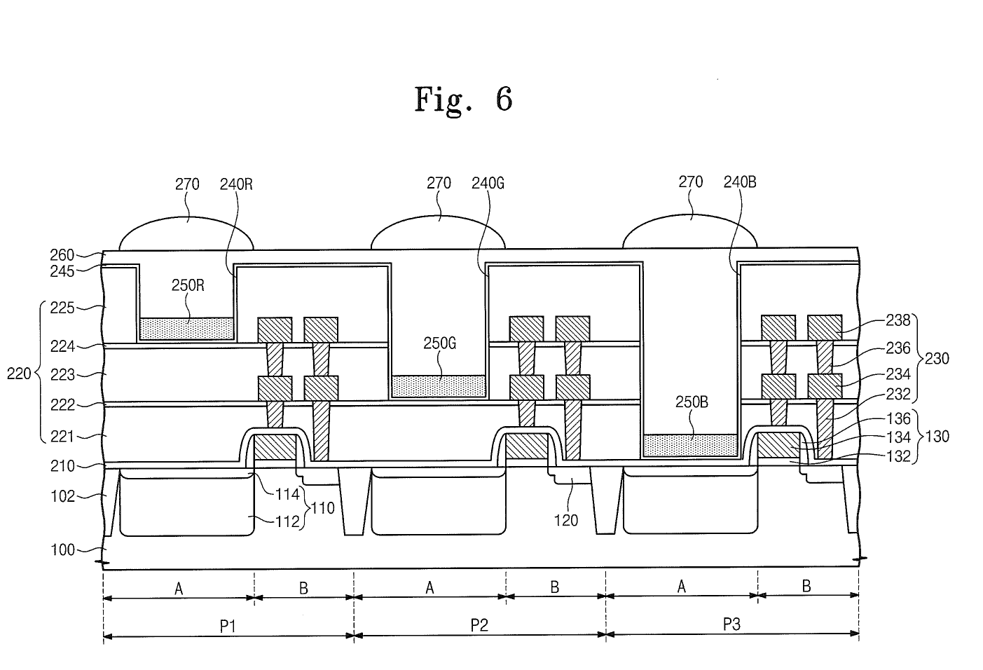

FIG. 6 is a cross-sectional view illustrating the CMOS image sensor according to still another embodiment of the inventive concept.

Referring to FIG. 6, the distances between the color filters 250R, 250G, and 250B and the photoelectric conversion devices 110 may be different from each other. For example, when the color filters 250R and 250G correspond to a red color filter and a green color filter respectively, the distance between the red color filter 250R and the photoelectric conversion device 110 in the first pixel region P1 may be greater than the distance between the green color filter 250G and the photoelectric conversion device 110 in the second pixel region P2. This is because a penetration depth of the red light passing through the red color filter 250R is greater than that of the green light passing through the green color filter 250G. That is, the penetration depths of the lights are due to the wavelengths thereof. Therefore, it may be possible to improve the light receiving efficiency (including a uniformity and an intensity) of both the red light and the green light when the distance between the red color filter 250R and the photoelectric conversion device 110 in the first pixel region P1 is greater than the distance between the green color filter 250G and the photoelectric conversion device 110 in the second pixel region P2. Similarly, when the color filters 250G and 250B correspond to a green color filter and a blue color filter respectively, the distance between the green color filter 250G and the photoelectric conversion device 110 in the second pixel region P2 may be greater than the distance between the blue color filter 250B and the photoelectric conversion device 110 in the third pixel region P3. As a result, according to the embodiment illustrate in FIG. 6, it is possible to reduce the loss of the lights passing through the color filters 250R, 250G, and 250B. As illustrated in FIG. 6, the distances between openings 240R, 240G, and 240B on the light-receiving regions A and the upper surfaces of the insulating structures 220 may be different from each other in the pixel regions P1, P2, and P3. That is, when the openings 240R, 240G, and 240B are formed in the insulating structures 220, the etching depths may be different from each other in the pixel regions P1, P2, and P3. More specifically, the distance between the bottom surface of the opening 240R in the first pixel region P1 and the upper surface of the semiconductor substrate 100 may be greater than the distance between the bottom surface of the opening 240G in the second pixel region P2 and the upper surface of the semiconductor substrate 100. In addition, the distance between the bottom surface of the opening 240G in the second pixel region P2 and the upper surface of the semiconductor substrate 100 may be greater than the distance between the bottom surface of the opening 240B in the third pixel region P3 and the upper surface of the semiconductor substrate 100.

The color filters 250R, 250G, and 250B are formed in the lower portions of the openings 240R, 240G, and 240B, respectively. The color filter 250B closest to the photoelectric conversion device 110 may be disposed at a lower level than the lowermost interconnection 234.

As described in the aforementioned embodiments, the openings 240R, 240G and 240B on the respective color filters 250R, 250G and 250B may be filled with the planarization layer 260 having the refractive index greater than the average refractive index of the insulating structure 220. Specifically, the planarization structure 260 may be formed of a material layer having a refractive index which is greater than that of a silicon oxide layer. For example, the planarization layer 260 may be formed of a material layer with a refractive index of about 1.4 to about 4.0. Alternatively, the planarization layer 260 may be formed of an organic material layer with a high refractive index.

As described above, the wavelength ranges of light depend on colors, and the penetration depths of the incident lights may be different from each other under the same conditions. That is, the penetration depth of long-wavelength light may be greater than that of short-wavelength light. In other words, the long-wavelength light may be incident up to the deep portion of the photoelectric conversion device 110 via the light transmission section. Therefore, it is possible to adjust the focal lengths of the incident light by adjusting the radii of curvature of the color filters 250R, 250G, and 250B when the color filters 250R, 250G, and 250B with the predetermined radii of curvature are formed in the openings 240R, 240G, and 240B with different depths, respectively, as illustrated in FIG. 5.

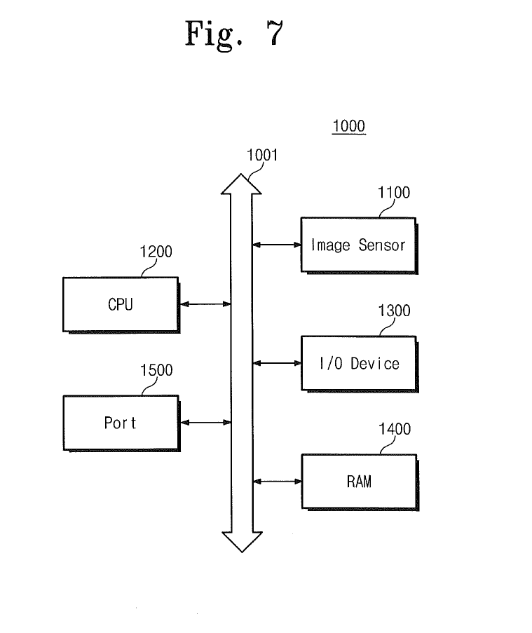

FIG. 7 is a schematic block diagram illustrating a processor-based system including the image sensor according to the embodiments of the inventive concept.

Referring to FIG. 7, the processor-based system 1000 is a system that processes output images of a CMOS image sensor 1100.

The system 1000 may include one of a computer system, a camera system, a scanner, a mechanical clock system, a navigation system, a video phone, a monitoring system, an automatic focus system, a tracking system, an operation monitoring system, and an image stabilizing system. However, the invention is not limited thereto.

The processor-based system 1000 such as a computer system may include a central processing unit (CPU) 1200 such as a microprocessor capable of communicating with an I/O device 1300 via a bus 1001. The CMOS image sensor 1100 may communicate with the CPU 1200 and/or the I/O device 1300 via the bus 1001 or another communication link. The processor-based system 1000 may further include a RAM 1400 and/or a port 1500 capable of communicating with the CPU 1200 through the bus 1001.

The port 1500 may be coupled with a video card, a sound card, a memory card, a USB device, or the like. Further, the port 1500 may be connected to an additional system to carry out data communication with the additional system. The CMOS image sensor 1100 may be integrated with a CPU, a digital signal processing device (DSP), or a microprocessor. Moreover, the CMOS image sensor 1100 may be integrated with a memory. Alternatively, the CMOS image sensor 1100 may be integrated in a chip different from that of a processor.

In the CMOS image sensor according to the embodiments of the inventive concept, since the color filter is formed in the opening for forming the optical waveguide, it may be possible to reduce the distance between the microlens and the photoelectric conversion device. Furthermore, it is possible to reduce the loss of the light incident on the photoelectric conversion device by filling the planarization layer having the refractive index larger than that of the insulating structure in the opening for forming the optical waveguide.

Although the preferred embodiment has been described in the specification with reference to the accompanying drawings, it is apparent to those skilled in the art that various substitution, modifications and changes may be thereto without departing from the scope and spirit of the invention. Therefore, the above-disclosed embodiments are to be considered illustrative and not restrictive.

What is claimed is:

1. An image sensor, comprising:
a photoelectric conversion device formed in a semiconductor substrate;
interlayer insulating layers laminated on an upper portion of the semiconductor substrate, the interlayer insulating layers defining an opening located on an upper portion of the photoelectric conversion device;
a color filter formed in the opening; and
a planarization layer filling the opening on the color filter and having a refractive index greater than an average refractive index of the interlayer insulating layers.

2. The image sensor of claim 1, wherein the planarization layer has a refractive index of 1.4 to 4.0.

3. The image sensor of claim 1, wherein the planarization layer includes an organic material.

4. The image sensor of claim 1, wherein the refractive index of the planarization layer is greater than that of the color filter.

5. The image sensor of claim 1, wherein the interlayer insulating layers include at least one of a silicon oxide layer, a silicon nitride layer, and a high-k dielectric layer.

6. The image sensor of claim 5, wherein the refractive index of the planarization layer is greater than that of the silicon oxide layer.

7. The image sensor of claim 1, wherein the color filter has a convex upper surface.

8. The image sensor of claim 1, further comprising a plurality of interconnections formed in the interlayer insulating layers and electrically connected to the photoelectric conversion device,
wherein the color filter is located at a lower level than a lowermost interconnection of the plurality of interconnections.

9. The image sensor of claim 1, further comprising:
a floating diffusion region spaced apart from the photoelectric conversion device and formed in the semiconductor substrate;
a charge transmission device disposed on the semiconductor substrate between the floating diffusion region and the photoelectric conversion device; and
an etching stop layer conformally formed along surfaces of the photoelectric conversion device, the floating diffusion region, and charge transmission device.

10. The image sensor of claim 9, wherein the opening exposes the etching stop layer.

11. The image sensor of claim 10, wherein the color filter be in contact with the etching stop layer.

12. The image sensor of claim 1, further comprising an antireflective layer covering an inner wall of the opening.

13. The image sensor of claim 1, wherein an upper width of the opening is greater than a lower width of the opening, and
wherein a sidewall of the opening is stepped.

14. The image sensor of claim 1, further comprising a microlens formed on the planarization layer above the photoelectric conversion device

15. An image sensor, comprising:
a semiconductor substrate having first to third pixel regions;
photoelectric conversion devices formed in the first to third pixel regions, respectively;
interlayer insulating layers laminated on an upper portion of the semiconductor substrate, the interlayer insulating layers defining openings located on upper portions of the photoelectric conversion devices;
color filters formed on bottom surfaces of the openings; and
a planarization layer filling the openings on the color filters and having a refractive index greater than an average refractive index of the interlayer insulating layers.

16. The image sensor of claim 15, further comprising a plurality of interconnections formed in the interlayer insulating layers and electrically connected to the photoelectric conversion devices,
wherein at least one of the color filters is located at a lower level than the lowermost interconnection of the plurality of interconnections.

17. The image sensor of claim 15, wherein each of the first to third pixel regions comprises:
a floating diffusion region spaced apart from the photoelectric conversion device and formed in the semiconductor substrate;
a charge transmission device disposed on the semiconductor substrate between the floating diffusion region and the photoelectric conversion device; and
an etching stop layer conformally formed along surfaces of the charge transmission device and the semiconductor substrate,
wherein the opening exposes the etching stop layer.

18. The image sensor of claim 15, wherein each of the color filters formed in the first to third pixel regions has a curvature radius.

19. The image sensor of claim 18, wherein the curvature radii of the color filters formed in the first to third pixel regions are different from each other.

20. The image sensor of claim 15, wherein a distance between the opening and the semiconductor substrate in the first pixel region is different from a distance between the opening and the semiconductor substrate in at least one of the second and third pixel regions.
